(19) United States
(12) Patent Application Publication
(10) Pub. No.: US 2008/0217417 A1
(43) Pub. Date: Sep. 11, 2008

(54) AIR CONDITIONER

(75) Inventors: Koji HATANO, Shiga (JP); Yoshiteru Ito, Shiga (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/034,148

(22) Filed: Feb. 20, 2008

(30) Foreign Application Priority Data
Mar. 5, 2007 (JP) 2007-053799
Apr. 20, 2007 (JP) 2007-111295

(51) Int. Cl. G05D 23/19

(52) U.S. Cl. 236/51

(57) ABSTRACT

An air conditioner includes an indoor unit, an outdoor unit, and an indoor controller which sets the conditions such as a condition of indoor air. The outdoor unit includes a compressor, an inverter for supplying electric power on a frequency in response to controls to the compressor, and an outdoor controller for controlling the compressor operation through the inverter. The outdoor controller includes a rewritable outdoor data memory for storing control data of the outdoor unit, and a microprocessor which refers to the control data stored in the outdoor data memory and follows a control program read from a ROM, thereby controlling the operation of the compressor. The indoor controller can write the control data of the outdoor unit into the outdoor data memory.

### FIELD OF THE INVENTION

The present invention relates to an air conditioner having an indoor controller, more particularly, it relates to an air conditioner operated according to control data of an outdoor unit, which control data is stored in a rewritable memory.

### BACKGROUND OF THE INVENTION

The foregoing air conditioner is typically formed of an indoor unit and an outdoor unit, and is regularly equipped with an indoor controller for setting the conditions of indoor air such as a temperature. A microprocessor has been recently used as a controller for operating the air conditioner because the air conditioners have become sophisticated and inexpensive.

A microprocessor working as a controller needs, in general, control data appropriate to respective models of the air conditioners in addition to a control program. Each one of the models must have its own appropriate control data, so that it has been difficult to share one type of controller with models having similar functions to each other.

In view of the foregoing situation, e.g. Unexamined Japanese Patent Publication No. H06-159761 discloses a technique that stores the control data in an external memory instead of in a ROM (read only memory) built-in the microprocessor. FIG. 9 shows a structure of an outdoor unit, employing a microprocessor, of a conventional air conditioner as discussed above.

As shown in FIG. 9, the outdoor unit is powered through AC power supply 101, and the AC power is converted to DC power by converter 102 before it is supplied to inverter 103. Inverter 103 is controlled by outdoor controller 106 for supplying AC power on different frequencies to compressor 104, so that the rpm of compressor 104 is changed. Outdoor controller 106 includes microprocessor 105 having ROM 108 built therein as well as nonvolatile memory 109. Microprocessor 105 follows a control program stored in ROM 108 and refers to control data stored in nonvolatile memory 109 for controlling inverter 103. The foregoing structure allows the outdoor unit of the conventional air conditioner to control an output frequency of inverter 103 with microprocessor 105, thereby variably controlling the rpm of compressor 104.

Nonvolatile memory 109 is an electrically erasable and writable nonvolatile memory placed outside the microprocessor 105. This configuration allows writing a variety of control data into memories 109 for adapting to respective models similar to each other, so that various control data can be adapted to respective models with more ease than a typical ROM.

However, the conventional art discussed above incurs the following problem. The variety of control data must be written in nonvolatile memories 109 at the production stage of the air conditioners though the outdoor units can adapt to respective models similar to each other. Therefore, at the time when control data is written into memory 109, the outdoor unit including this memory 109 becomes a unit proper to a specific model of air conditioners, and must be distinguished from other similar outdoor units. This outdoor unit thus must be paired with the specific indoor unit when the air conditioner is shipped out from the factory. The outdoor unit of the conventional air conditioner needs to be controlled such that the unit is paired with a given indoor unit at the production stage and the distribution stage, so that the conventional air conditioners incur a loss in the production as well as in the inventory control.

In the event of repairing the air conditioner, when outdoor controller 106 is replaced with another one as an assembled unit, respective outdoor controllers 106 with the respective control data written-in must be controlled individually as independent components of each other. To the contrary, outdoor controllers 106 free from the control data written-in can be controlled as a component common to any air conditioners; however, in this case, writing the control data into a memory with a special tool is needed when this outdoor controller 106 is mounted to the air conditioner.

### SUMMARY OF THE INVENTION

The present invention addresses the foregoing problem and aims to provide an air conditioner including an indoor unit, outdoor unit, and indoor controller which sets the conditions such as a condition of indoor air. The outdoor unit includes a compressor, inverter which supplies electric power to the compressor on a frequency in response to the controls, and an outdoor controller which controls the operation of the compressor through the inverter. The outdoor controller includes a rewritable outdoor data memory, which stores control data of the outdoor unit, and a microprocessor that refers to the control data stored in the outdoor data memory and follows a control program read from a memory storing the control program for operating the compressor. The indoor controller can write the control data of the outdoor unit into the outdoor data memory.

The foregoing structure tells that an outdoor data white-memory of the air conditioner of the present invention can be generally used as a component common to respective models of the air conditioners similar to each other. At the same time, after the air conditioner is installed, the indoor controller allows writing the control data into the outdoor data memory, so that the outdoor unit can be handled for a specific model of the air conditioners. At the production stage and the distribution stage, it is not needed any more to consider pairing the outdoor unit with a specific indoor unit, and the loss can be thus reduced. At the repairing stage, the outdoor unit with an outdoor data white-memory can be simply handled as a component common to the air conditioners, and it is not needed any more to control the inventory of the outdoor unit as an item to be paired with a specific air conditioner.

### BRIEF DESCRIPTION OF THE DRAWINGS

FIG. 1 shows a block diagram of an air conditioner in accordance with a first embodiment of the present invention.

FIG. 2 shows a block diagram of an air conditioner in accordance with a second embodiment of the present invention.

FIG. 3 shows a block diagram of an air conditioner in accordance with a third embodiment of the present invention.

FIG. 4 shows a block diagram of an air conditioner in accordance with a fourth embodiment of the present invention.

FIG. 5 shows a block diagram of an air conditioner in accordance with a fifth embodiment of the present invention.

FIG. 6 shows a block diagram of another structure of the air conditioner in accordance with the fifth embodiment of the present invention.

FIG. 7 shows a block diagram of still another structure of the air conditioner in accordance with the fifth embodiment of the present invention.

FIG. 8 shows a block diagram of yet another structure of the air conditioner in accordance with the fifth embodiment of the present invention.

FIG. 9 shows a block diagram of an outdoor unit of a conventional air conditioner.

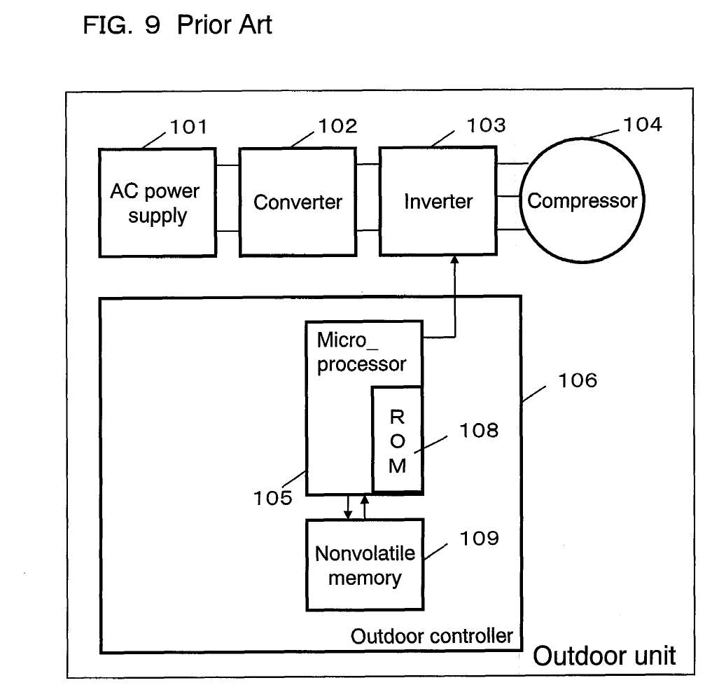

### DETAILED DESCRIPTION OF PREFERRED EMBODIMENTS

Exemplary embodiments of the present invention are demonstrated hereinafter with reference to the accompanying drawings.

### Embodiment 1

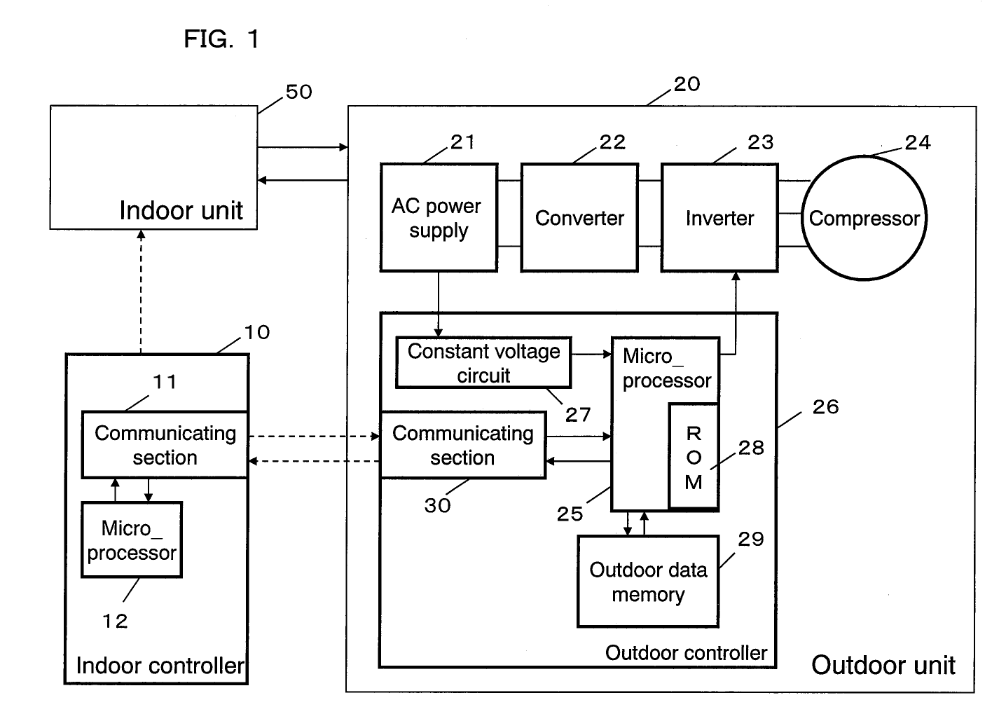

FIG. 1 shows a block diagram of an air conditioner in accordance with the first embodiment of the present invention. As shown in FIG. 1, the air conditioner includes indoor controller 10, outdoor unit 20, and indoor unit 50. Indoor controller 10 is a remote control for setting the conditions such as a condition of indoor air. A user of the air conditioner operates indoor controller 10, which transmits an operation signal to indoor unit 50 by using infrared rays. The user thus can set a target temperature of cooling or heating by the air conditioner with indoor controller 10, which is thus equipped with microprocessor 12 for executing such processes as a remote control.

Outdoor unit 20 includes AC power supply 21, converter 22, inverter 23, compressor 24, and outdoor controller 26. AC power supply 21 outputs commercial AC power, and converter 22 rectifies the AC power and outputs DC power. Inverter 23 converts this DC power to AC power again, and outputs this AC power to compressor 24. Outdoor controller 26 supplies a rotary control signal to inverter 23, which supplies AC power on a frequency in response to the control of the rotary control signal. An rpm of compressor 24 can be thus changed in response to the rotary control signal supplied from outdoor controller 26. In other words, outdoor controller 26 controls inverter 23 with the rotary control signal, thereby controlling the rotary operation of compressor 24 via inverter 23.

Outdoor controller 26 includes microprocessor 25, constant voltage circuit 27, outdoor data memory 29, and communicating section 30. Constant voltage circuit 27 converts the AC power supplied from AC power supply 21 to a DC power at a low and constant voltage in order to operate microprocessor 25, and supplies the DC power to microprocessor 25.

Microprocessor 25 includes ROM 28 that is a memory stored a control program for operating microprocessor 25. ROM 28 is a read only nonvolatile memory. Microprocessor 25 sequentially reads the control programs stored in ROM 28, and executes the process following the programs. A memory like ROM 28 storing the control program can be in another style such as a memory placed outside the microprocessor 25, or a memory other than a ROM.

Outdoor data memory 29 is placed outside the microprocessor 25 for storing control data. Memory 29 is a rewritable memory of which data can be erased and rewritten. The air conditioner in accordance with this embodiment, in particular, employs an electrically erasable and writable nonvolatile memory such as EEPROM (electrical erasable programmable ROM) as outdoor data memory 29 of outdoor controller 26 in outdoor unit 20. The control data to be stored in memory 29 is the data for executing the controls in outdoor unit 20 in response to a given model of the air conditioner. According to respective models of the air conditioners, memories 29 thus store a variety of control data. Microprocessor 25 reads the control data stored memory 29, and carries out the process following the control program while it refers to the control data.

The foregoing structure of outdoor controller 26 allows microprocessor 25 to refer to the control data stored in outdoor data memory 29 and to follow the control program read from ROM 28 for controlling inverter 23, thereby controlling the operation of compressor 24.

The air conditioner of the present invention advantageously includes communicating section 30, which can communicate with indoor controller 10, at outdoor controller 26 of outdoor unit 20. Indoor controller 10 thus implements a communication via communicating section 30 in addition to the communication function (not shown) of transmitting an operation signal to indoor unit 50, so that it has communicating section 11 that can communicate with outdoor controller 26. Data can be transmitted between communicating section 30 of outdoor controller 26 and microprocessor 25. Data can be also transmitted between communicating section 11 of indoor controller 10 and microprocessor 12. Both of indoor controller 10 and outdoor controller 26 thus include communicating sections 11 and 30 which can communicate with each other.

The configuration discussed above allows an operation of indoor controller 10 to prompt microprocessor 12 to transmit data to microprocessor 25 via communicating sections 11 and 30. The air conditioner of the present invention thus allows indoor controller 10 to transmit the control data of outdoor unit 20 to microprocessor 25 via the communicating means formed of communicating sections 11 and 30. Microprocessor 25 receives the control data thus transmitted, and stores the data in outdoor data memory 29.

The air conditioner in accordance with this first embodiment allows indoor controller 10 to write the control data of outdoor unit 20 into outdoor data memory 29. The communication between communicating sections 11 and 30 can be either one of wire communication or wireless communication.

As discussed above, the air conditioner in accordance with the embodiment employs a rewritable memory as outdoor data memory 29, and allows indoor controller 10 to transmit the control data, supposed to be written into outdoor data memory 29, to memory 29. At the production stage, outdoor controller 26 can be equipped with a white memory as outdoor data memory 29, and it is not needed to prepare control data proper to each model of the air conditioners. After installing the air conditioner, control data proper to this model is written into outdoor data memory 29 from indoor controller 10 so that this air conditioner can function properly. Outdoor unit 20 can be thus handled as a component common to any models similar to each other at production, distribution, and repairing stages, and it becomes a component proper to a specific model after the installation. No attention is thus needed to the pairing of the outdoor unit with a specific indoor unit at the production and distribution stages, so that the loss incurred in the inventory control at the production and distribution stages can be reduced. At the repairing stage, if no control data is written in the outdoor data memory, the outdoor unit can be handled as a component common to any models similar to each other, and is not needed to be handled as a component proper to a specific model.

### Embodiment 2

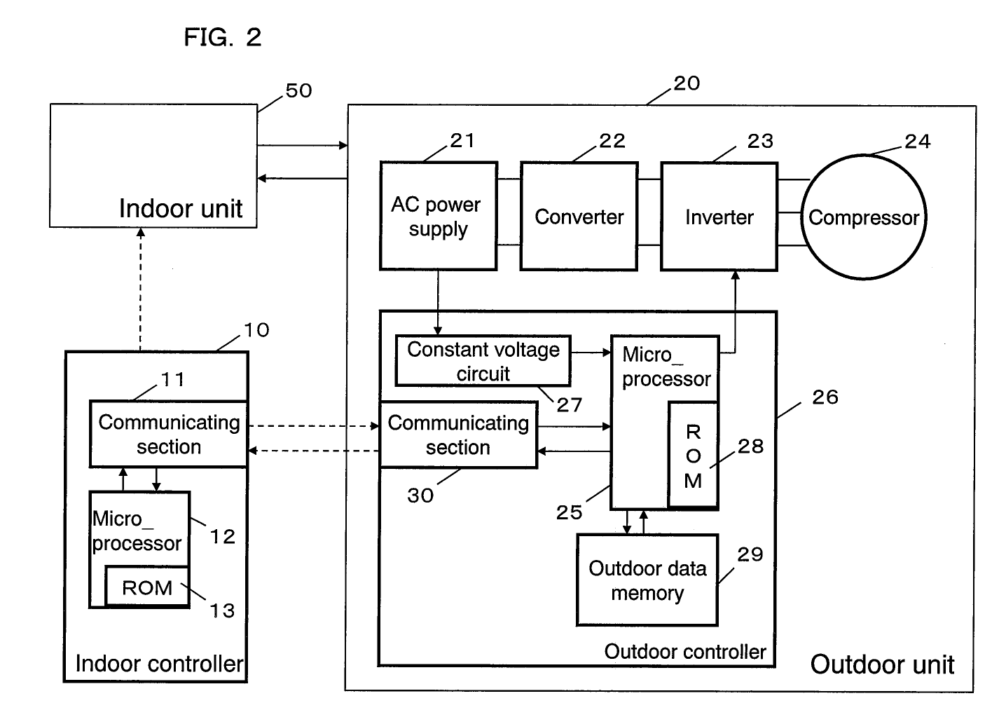

FIG. 2 shows a block diagram of an air conditioner in accordance with the second embodiment. The air conditioner differs from the one discussed in the first embodiment in additional ROM 13 placed at indoor controller 10. ROM 13 stores control data proper to a specific model of air conditioners. In FIG. 2, elements similar to those used in the first embodiment have the same reference marks, and the detailed descriptions thereof are omitted here.

Indoor controller 10 of the air conditioner is equipped with ROM 13, in other words, indoor controller 10 is a component proper to this model of air conditioners. Indoor controller 10 can write the control data proper to this model into outdoor data memory 29 of outdoor unit 20. ROM 13 stores a program which executes microprocessor 12. ROM 13 can also store the foregoing control data together with this program. The control data; however, can be stored in a memory placed outside the microprocessor 12 or in a nonvolatile memory other than ROM.

As discussed above, the air conditioner in accordance with this embodiment employs a rewritable memory as outdoor data memory 29, and allows indoor controller 10 to transmit the control data, which is proper to a specific model and supposed to be addressed in outdoor data memory 29, to memory 29. At the production stage, outdoor controller 26 can be equipped with a white memory as outdoor data memory 29, and it is not needed to prepare control data proper to each model of the air conditioners. After installing the air conditioner, the control data proper to this model is written into outdoor data memory 29 from indoor controller 10 so that this air conditioner can function properly. Outdoor unit 20 can be thus handled as a component common to any models similar to each other at production, distribution, and repairing stages, and it becomes a component proper to a specific model after the installation. No attention is thus needed to the pairing of the outdoor unit with a specific indoor unit at the production and distribution stages, so that the loss incurred in the inventory control at the production and distribution stages can be reduced. At the repairing stage, if no control data is written in the outdoor data memory, the outdoor unit can be handled as a component common to any models similar to each other, and is not needed to be handled as a component proper to a specific model.

### Embodiment 3

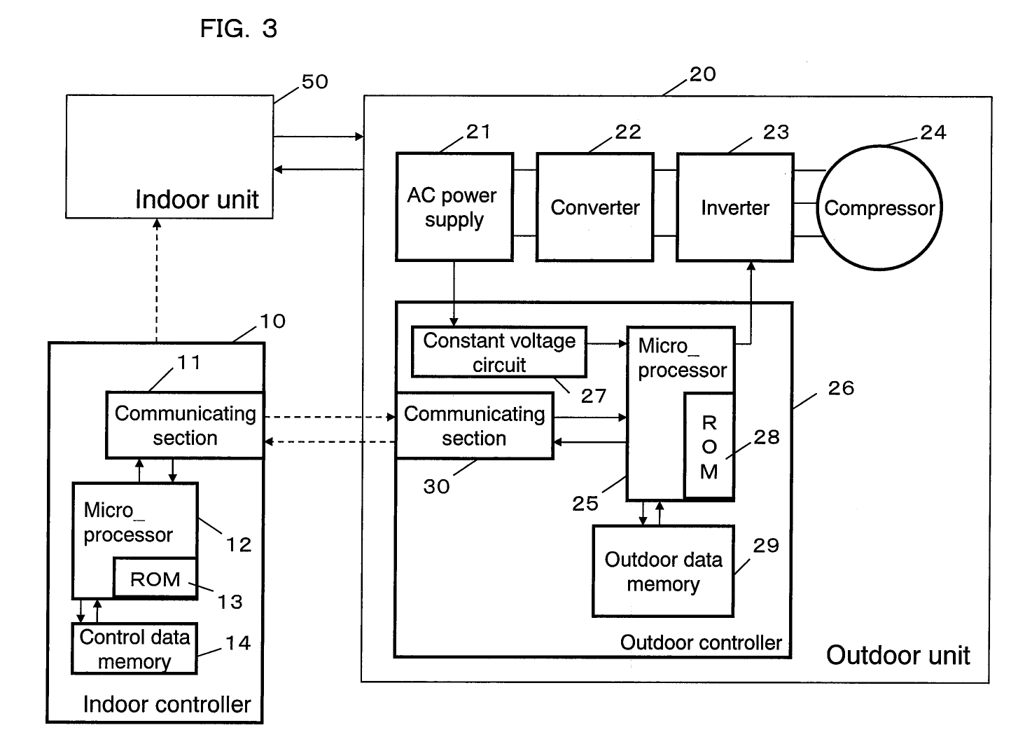

FIG. 3 shows a block diagram of an air conditioner in accordance with the third embodiment. The air conditioner differs from the one discussed in the second embodiment in additional control data memory 14 placed at indoor controller 10. Memory 14 stores control data proper to given models of air conditioners. In FIG. 3, elements similar to those used in the second embodiment have the same reference marks, and the detailed descriptions thereof are omitted here.

As shown in FIG. 3, microprocessor 12 of indoor controller 10 in the air conditioner in accordance with this third embodiment reads a program from ROM 13 built therein, and executes respective processes following this program.

Control data memory 14 is a nonvolatile memory placed outside the microprocessor 12, and stores control data proper to a plurality of models of air conditioners similar to each other. For instance, when indoor controller 10 receives a command of transmitting the control data, microprocessor 12 reads the control data of the model specified in the command, and the control data is transmitted, following the command of microprocessor 12, to microprocessor 25 via communicating sections 11 and 30. Then microprocessor 25 writes the control data received into outdoor data memory 29.

As discussed above, indoor controller 10 of the air conditioner in accordance this third embodiment selects a model out of the plurality of models, and writes the control data proper to this model of air conditioners into outdoor data memory 29 of outdoor controller 26 via wire communication or wireless communication. This structure allows indoor controller 10 to adapt itself to plurality of models similar to each other, so that indoor controller 10 becomes more widely adaptable to the models.

As discussed above, the air conditioner in accordance with this embodiment employs a rewritable memory as outdoor data memory 29, and allows indoor controller 10 to transmit the control data, which is proper to a specific model and supposed to be written into outdoor data memory 29, to memory 29. At the production stage, outdoor controller 26 can be equipped with a white memory as outdoor data memory 29, and it is not needed to prepare control data proper to each model of the air conditioners. After installing the air conditioner, the control data proper to this model is written into outdoor data memory 29 from indoor controller 10 so that this air conditioner can function properly. Outdoor unit 20 can be thus handled as a component common to any models similar to each other at production, distribution, and repairing stages, and it becomes a component proper to a specific model after the installation. No attention is thus needed to the pairing of the outdoor unit with a specific indoor unit at the production and distribution stages, so that the loss incurred in the inventory control at the production and distribution stages can be reduced. At the repairing stage, if no control data is written in the outdoor data memory, the outdoor unit can be handled as a component common to any models similar to each other, and is not needed to be handled as a component proper to a specific model. Indoor controller 10 of the air conditioner in accordance with this third embodiment stores, in advance, the control data of a plurality of models, so that indoor controller 10 can be adapted to a wider range of the models.

### Embodiment 4

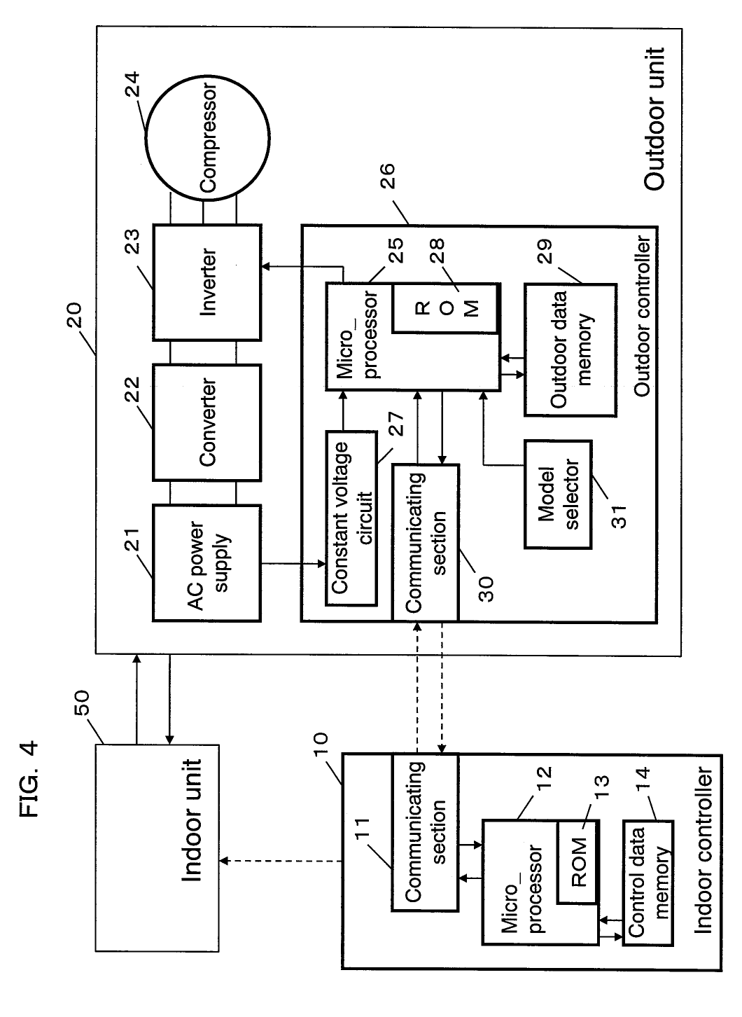

FIG. 4 shows a block diagram of an air conditioner in accordance with the fourth embodiment. The air conditioner differs from the one discussed in the third embodiment in the following two points: (1) model selector 31 is added to outdoor controller 26, and (2) ROM 28 built in microprocessor 25 stores the data for driving the compressor of respective models, together with a control program. In FIG. 4, elements similar to those used in the third embodiment have the same reference marks, and the detailed descriptions thereof are omitted here.

As shown in FIG. 4, microprocessor 25 of outdoor controller 26 in the air conditioner in accordance with this fourth embodiment reads a program from ROM 28 built therein, and executes respective processes following this program. ROM 28 stores, in advance, the data for driving compressors of respective models similar to each other. This data is used for driving compressor 24; however, it must be set appropriately to the motor built in compressor 24. The data for driving the compressor is appropriately selected and determined by model selector 31, e.g. at the production stage. To be more specific, model selector 31 selects the driving data proper to a specific model out of the data of a plurality of models. In the selection by model selector 31, other selections of basic functions can be done, such as an output of the specific model, a cooling exclusively model, or a cooling and heating model.

Similar to the third embodiment, an operation of indoor controller 10 prompts selecting the control data proper to a given model of the air conditioners. The control data including the information about the selected model is transmitted from indoor controller 10 to microprocessor 25 in outdoor unit 20 via communicating sections 11 and 30.

Then microprocessor 25 refers to the model information for determining whether or not the model selected by indoor controller 10 agrees with the model selected by model selector 31. On finding the agreement, microprocessor 25 writes the control data transmitted from indoor controller 10 into outdoor data memory 29.

As discussed above, on finding the agreement between the model information received from indoor controller 10 and the model selected by model selector 31, microprocessor 25 writes the received control data into outdoor data memory 29. This structure allows preventing a use of wrong control data because the control data proper to a specific model is written into outdoor data memory 29 only when the model set by indoor controller 10 agrees with the model selected by model selector.

The air conditioner in accordance with this embodiment, as discussed above, employs a rewritable memory as outdoor data memory 29, and allows indoor controller 10 to transmit the control data, which is proper to a specific model and supposed to be written in outdoor data memory 29, to memory 29. At the production stage, outdoor controller 26 can be equipped with a white memory as outdoor data memory 29, and it is not needed to prepare control data proper to each model of the air conditioners. After installing the air conditioner, the control data proper to this model is written into outdoor data memory 29 from indoor controller 10 so that this air conditioner can function properly. Outdoor unit 20 can be thus handled as a component common to any models similar to each other at production, distribution, and repairing stages, and it becomes a component proper to a specific model after the installation. No attention is thus needed to the pairing of the outdoor unit with a specific indoor unit at the production and distribution stages, so that the loss incurred in the inventory control at the production and distribution stages can be reduced. At the repairing stage, if no control data is written in the outdoor data memory, the outdoor unit can be handled as a component common to any models similar to each other, and is not needed to be handled as a component proper to a specific model. Indoor controller 10 of the air conditioner in accordance with this third embodiment stores, in advance, the control data of a plurality of models, so that indoor controller 10 can be adapted to a wider range of the models. On top of that, microprocessor 25 built in outdoor controller 26 writes the received control data into outdoor data memory 29 only when the agreement is found between the model information received from indoor controller 10 and the model selected by model selector 31. This structure allows preventing a use of wrong control data.

Microprocessors 25 and 12 can be configured to do the following processes in order to enhance the convenience of the air conditioner of the present invention or to prevent an erroneous operation on setting control data: For instance, when the air conditioner is installed, microprocessor 25 built in outdoor controller 26 determines whether or not outdoor data memory 29 stores control data at the initial power-on, and notifies indoor controller 10 of the determination. If controller 10 receives a notice of no control data from microprocessor 25, controller 10 transmits the control data to microprocessor 25, which then writes the control data into outdoor memory 29. This process can be added to the functions of microprocessor 25. On top of that, when microprocessor 25 notifies indoor controller 10 of the determination discussed above, it also notifies controller 10 of the information about the model selected by model selector 31. Microprocessor 12 built in indoor controller 10 selects the control data from control data memory 14 based on the information notified, and then transmits the selected control data to microprocessor 25, which then writes the received control data into outdoor data memory 29. This function can be further added. Those functions added to the air conditioner of the present invention will eliminate a special tool for writing the control data, and can select the necessary control data.

The air conditioner of the present invention can be configured as follows: When microprocessor 25 determines that outdoor data memory 29 does not store necessary data, it demands that indoor controller 10 transmit control data. Controller 10 transmits the control data to microprocessor 25 on the demand. Then microprocessor 25 writes the received control data into outdoor data memory 29. In other words, the configuration discussed above works as follows: when outdoor data memory 29 stores no necessary data, microprocessor 25 demands that controller 10 transmit control data, and then controller 10 transmits the control data in response to this demand to outdoor data memory 29 via wire or wireless communication. This configuration allows eliminating the special tool for writing the control data, and selecting appropriate control data even after outdoor data memory 29 is initialized, as well as, after indoor controller 10 selects a model.

### Embodiment 5

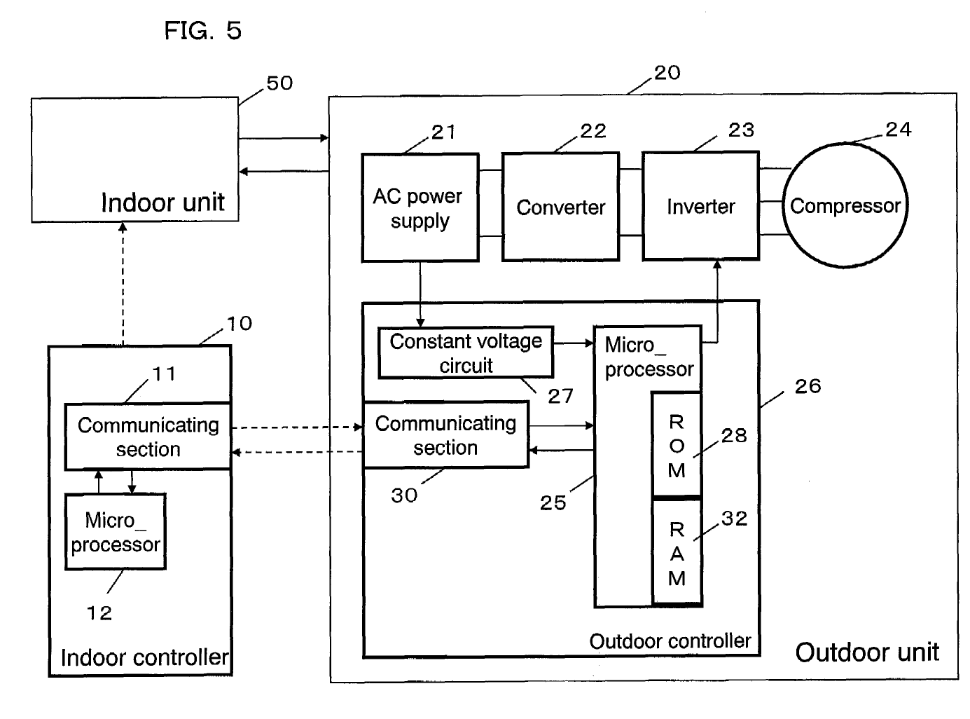

FIG. 5 shows a block diagram of an air conditioner in accordance with the fifth embodiment. The air conditioner differs from the one discussed in the first embodiment in RAM (random access memory) 32 replacing outdoor data memory 29 of outdoor controller 26 shown in FIG. 1. RAM 32 is an electrically rewritable and volatile memory and is used as an outdoor data memory in microprocessor 25. To be more specific, ROM 28 built in microprocessor 25 of the air conditioner of the present invention stores a control program, and RAM 32 stores the control data as discussed above. In FIG. 5, elements similar to those used in the first embodiment have the same reference marks, and the detailed descriptions thereof are omitted here.

In the air conditioner shown in FIG. 5, microprocessor 25 sequentially reads the control programs stored in ROM 28, and executes the processes following the programs. A memory like ROM 28 storing the control program can be in another style such as a memory placed outside the microprocessor 25, or a memory other than a ROM.

Microprocessor 25 has RAM 32 therein for storing control data. RAM 32 is an erasable and writable memory, so that the data stored therein can be erased and rewritten, and outdoor unit 20 controls the air conditioner model-wise based on the data stored in RAM 32, which therefore stores different control data according to the models of air conditioners. Microprocessor 25 reads the control data stored in RAM 32 and refers to this data for executing the processes following the control programs.

Outdoor controller 26 is equipped with communicating section 30 through which controller 26 can communicate with indoor controller 10, so that operation of controller 10 allows transmitting data from microprocessor 12 to microprocessor 25 via communicating sections 11 and 30. To be more specific, in the air conditioner in accordance with this fifth embodiment, indoor controller 10 transmits, via communicating sections 11 and 30, the control data of outdoor unit 20 to microprocessor 25, which then stores the received control data in RAM 32. As discussed above, indoor controller 10 allows the control data of outdoor unit 20 to be written into RAM 32 serving as the outdoor data memory.

The air conditioner in accordance with the fifth embodiment includes RAM 32 which is rewritable at its outdoor controller 26, and allows indoor controller 10 to transmit the control data to RAM 32. This structure allows outdoor controller 26 to be equipped with RAM 32 common to other controllers 26 at the production stage of the air conditioners, so that it is not needed to prepare control data proper to respective models. After installing the air conditioner, control data proper to this model is written into RAM 32 from indoor controller 10, so that this air conditioner can function properly. Outdoor unit 20 can be thus handled as a component common to any models similar to each other at production, distribution, and repairing stages, and it becomes a component proper to a specific model after the installation. No attention is thus needed to the pairing of the outdoor unit with a specific indoor unit at the production and distribution stages, so that the loss incurred in the inventory control at the production and distribution stages can be reduced. At the repairing stage, if no control data is written in the outdoor data memory, the outdoor unit can be handled as a component common to any models similar to each other, and is not needed to be handled as a component proper to a specific model.

In the descriptions discussed previously, structures similar to the one shown in FIG. 1 and discussed in the first embodiment are taken as examples; however, the present invention is not limited to those examples. In other words, the functions discussed in embodiments 2, 3 and 4 can be added to this fifth embodiment for establishing another structure of the fifth embodiment.

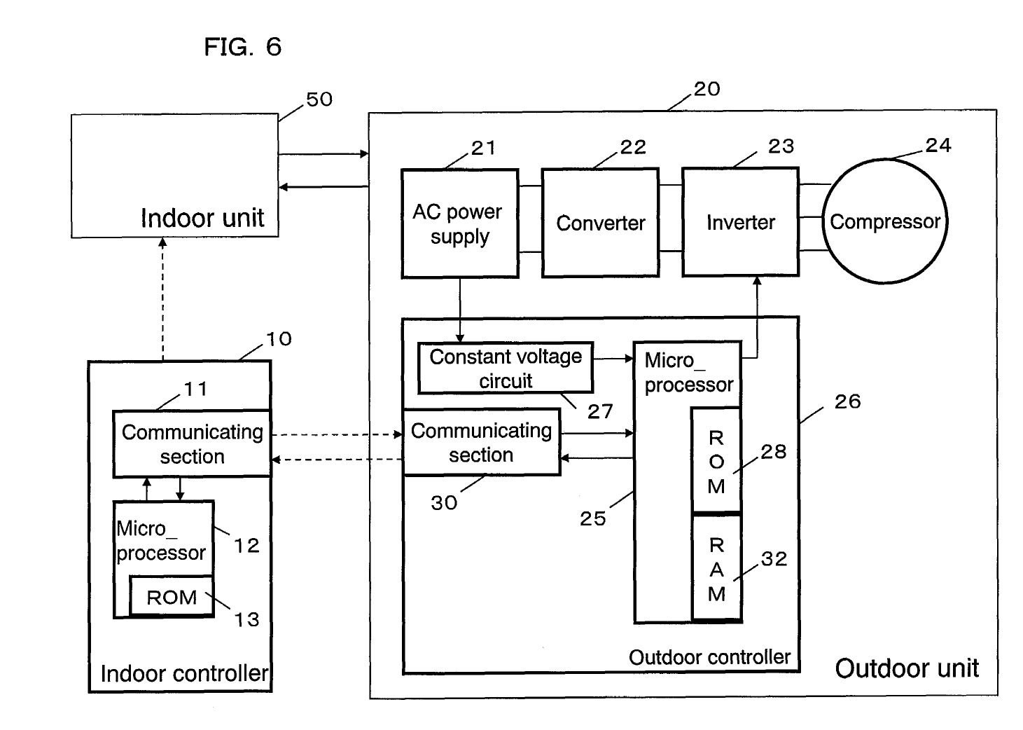

FIG. 6 shows another structure in accordance with the fifth embodiment. This another structure includes rewritable RAM 32 at outdoor controller 26 as shown in FIG. 5, and it also includes ROM 13 as shown in FIG. 2 at indoor controller 10 for storing the control data proper to a specific model.

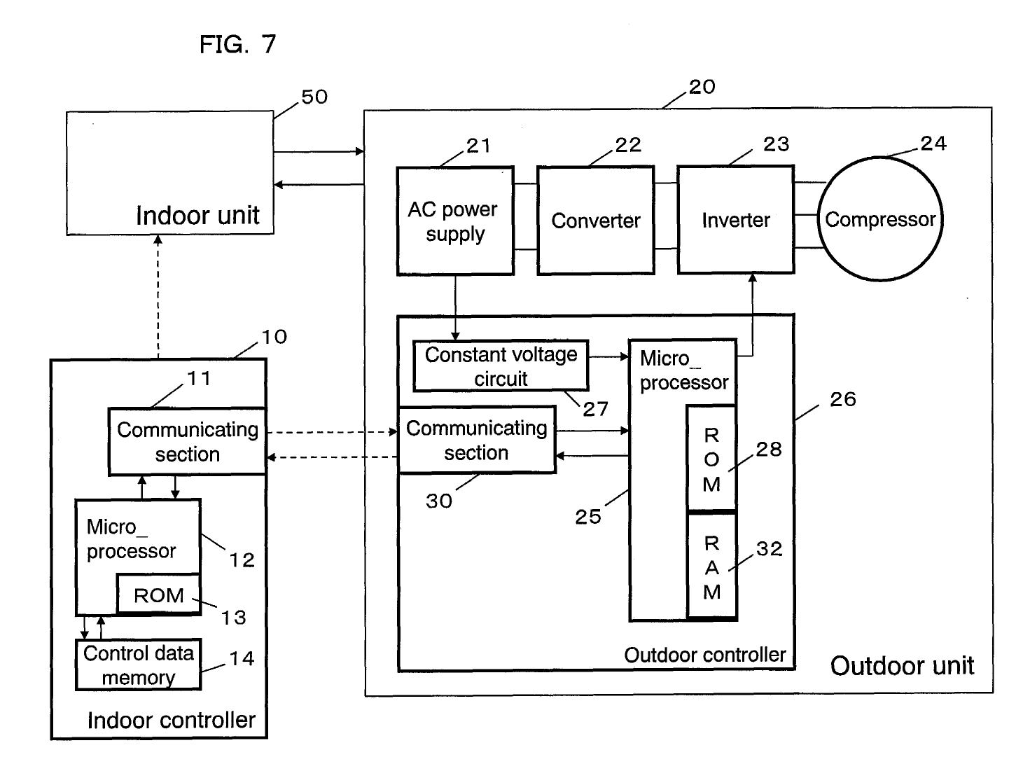

FIG. 7 shows still another structure in accordance with the fifth embodiment. This another structure includes rewritable RAM 32 at outdoor controller 26 as shown in FIG. 5, and it also includes control data memory 14 at indoor controller 10 as shown in FIG. 3 for storing respective control data for each model of the air conditioners.

These structures allow indoor controller 10 to store, in advance, the control data of a plurality models similar to each other, so that the indoor units can be adapted to a wider range of outdoor units.

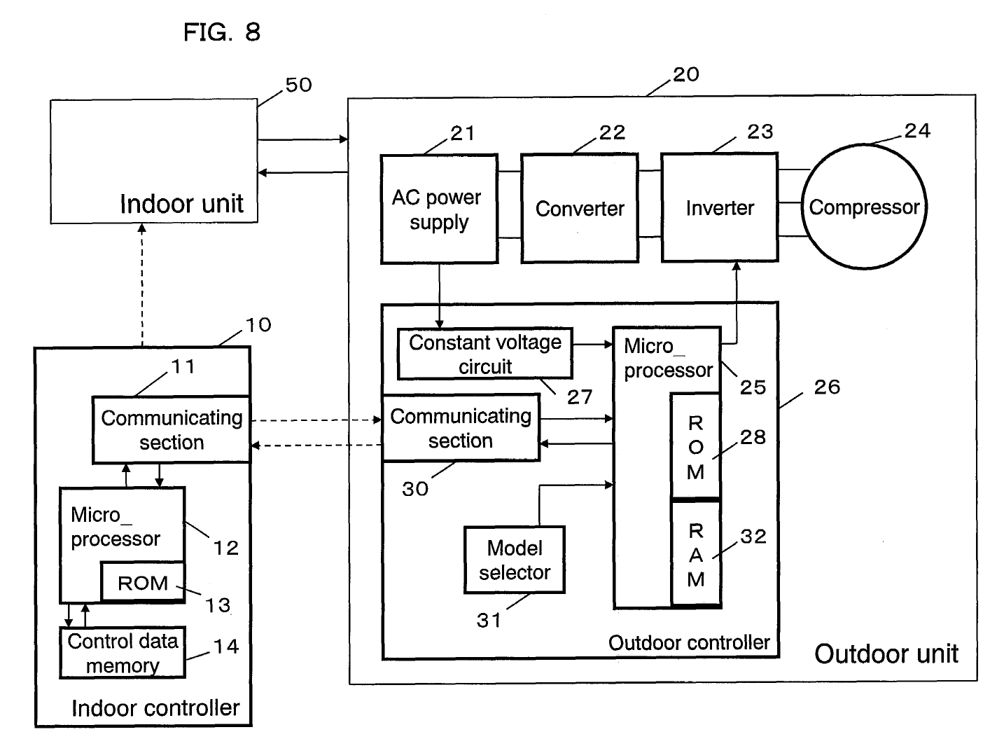

FIG. 8 shows yet still another structure in accordance with the fifth embodiment. This another structure includes rewritable RAM 32 at outdoor controller 26 as shown in FIG. 5, and it also includes model selector 31 at outdoor controller 26 as shown in FIG. 4. To be more specific, microprocessor 25 writes the control data received from inner controller 10 only when the model information received from controller 10 agrees with the model selected by model selector 31. This structure allows preventing a use of wrong control data because the control data proper to a specific model is written into RAM 32 only when the model set by indoor controller 10 agrees with the model selected by model selector 31.

The air conditioner in accordance with the fifth embodiment can be configured this way: When microprocessor 25 determines that RAM 32 does not store necessary data, it demands that indoor controller 10 transmit the control data. On this demand, controller 10 transmits the control data to microprocessor 25, which then writes the received control data into RAM 32. The function executing the processes discussed above can be added. To be more specific, when RAM 32 does not store necessary data, microprocessor 25 demands that indoor controller 10 transmit control data. On this demand, controller 10 writes the control data into RAM 32 through wire or wireless communication. This structure allows eliminating a special tool for writing control data and it also allows selecting the appropriate control data even after RAM 32 at outdoor controller 26 is initialized due to an instantaneous interruption of service or after the model is selected by indoor controller 10.

The air conditioner of the present invention as discussed above allows the indoor controller to write the control data of the outdoor unit into the outdoor data memory. This structure allows paying no attention to the pairing of the outdoor unit with a specific indoor unit, and the loss incurred in inventory control at the production and distribution stages can be reduced. As a result, small batches of a variety of models can be produced efficiently. The present invention is thus useful for air conditioners with an indoor controller.

What is claimed is:

1. An air conditioner comprising:
an indoor unit;
an outdoor unit; and
an indoor controller for setting conditions including a condition of indoor air,
wherein the outdoor unit includes:
a compressor;
an inverter for supplying electric power on a frequency in response to controls; and
an outdoor controller for controlling the compressor operation through the inverter,
wherein the outdoor controller includes:
a rewritable outdoor data memory for storing control data of the outdoor unit; and
a microprocessor referring to the control data stored in the outdoor data memory, and following a control program stored in a memory for controlling operation of the compressor;
wherein the indoor controller can write the control data of the outdoor unit into the outdoor data memory.

2. The air conditioner of claim 1, wherein the indoor controller and the outdoor controller include a communicating section through which the indoor controller and the outdoor controller can communicate with each other, and the control data transmitted from the indoor controller through the communicating sections is written into the outdoor data memory.

3. The air conditioner of claim 1, wherein the control data is proper to a model of the air conditioners.

4. The air conditioner of claim 1, wherein the indoor controller stores the control data of respective models of the air conditioners, and writes one of the control data of a model, selected out of a plurality of the models, into the outdoor data memory.

5. The air conditioner of claim 4, wherein the indoor controller transmits information about the selected model together with the control data to the microprocessor of the outdoor unit, and the microprocessor writes the received control data into the outdoor data memory.

6. The air conditioner of claim 5, wherein the memory storing the control program also stores data of driving the compressor of the respective models,
wherein the outdoor controller further includes a model selector for selecting the data of driving the compressor proper to the model out of the data of driving the compressors of a plurality of models,
wherein the microprocessor writes the received control data into the outdoor data memory when the model information received from the indoor controller agrees with the model selected by the model selector.

7. The air conditioner of claim 1, wherein the microprocessor determines whether or not the outdoor data memory stores the control data at an initial power-on, and notifies the indoor controller of a result of the determination,
wherein a reception of a notice that the control data is not stored prompts the indoor controller to transmit the control data to the microprocessor, which then writes the control data received from the indoor controller into the outdoor data memory.

8. The air conditioner of claim 1, wherein when the microprocessor determines that necessary data is not written in the outdoor data memory, the microprocessor demands that the indoor controller transmit the control data, and when the indoor controller receives the demand from the microprocessor, the indoor controller transmits the control data to the microprocessor, which then writes the control data received from the indoor controller into the outdoor data memory.

9. The air conditioner as defined in any one of claim 1-claim 8, wherein the outdoor data memory is an electrically erasable and writable nonvolatile memory.

10. The air conditioner as defined in any one of claim 1-claim 8, wherein the outdoor data memory is an electrically erasable and writable random access memory.
